(19) United States
(12) Patent Application Publication
(10) Pub. No.: US 2025/0124439 A1
(43) Pub. Date: Apr. 17, 2025

(54) Electronic Devices and Corresponding Methods for Executing Unsafe Conditions Operations Causing Applications to Operate in Abnormal Modes of Operation

(71) Applicant: Motorola Mobility LLC, Chicago, IL (US)

(72) Inventors: Vignesh Karthik Mohan, Bangalore (IN); Krishnan Raghavan, Bangalore (IN); Rahul Sahadevan, Kerala (IN)

(21) Appl. No.: 18/380,470

(22) Filed: Oct. 16, 2023

(51) Int. Cl. G06Q 20/40; G06F 21/32

(52) U.S. Cl. CPC G06Q 20/40145; G06F 21/32

(57) ABSTRACT

An electronic device includes one or more sensors, a user interface that has one or more user input output devices, and one or more processors operable with the one or more sensors and the user interface. The one or more processors receive an unsafe conditions command and, in response, cause a financial application or banking application to operate in an abnormal mode of operation. In the abnormal mode of operation, the financial application or banking application may present an incorrect balance, present one or more fictitious transactions or statements, may preclude the presentation of notifications, or perform other operations protecting personal and financial data structures.

### BACKGROUND

### Technical Field

This disclosure relates generally to electronic devices, and more particularly to electronic devices having sensors.

### Background Art

Mobile communication devices are becoming increasingly powerful. Today's smartphone packs more computing power than the desktop computers of only a few years ago. All of this computing power brings increased functionality. Accordingly, users use electronic communication for all types of activities. In addition to voice, text, and multimedia communication, users employ devices such as smartphones to execute financial transactions, record, analyze, and store medical information, store pictorial records of their lives, maintain calendar, to-do, and contact lists, and even perform personal assistant functions.

Where an electronic device contains so much personal information, it can be quite disconcerting to lose the device, have it stolen, or have applications utilizing personal or financial information compromised by nefarious actors. An improved electronic device to facilitate recovery in such situations would be advantageous.

### BRIEF DESCRIPTION OF THE DRAWINGS

FIG. 1 illustrates one explanatory system in accordance with one or more embodiments of the disclosure.

FIG. 2 illustrates one explanatory electronic device in accordance with one or more embodiments of the disclosure.

FIG. 3 illustrates explanatory method in accordance with one or more embodiments of the disclosure.

FIG. 4 illustrates one or more method steps in accordance with one or more embodiments of the disclosure.

FIG. 5 illustrates one or more optional method steps in accordance with one or more embodiments of the disclosure.

FIG. 6 illustrates another explanatory method in accordance with one or more embodiments of the disclosure.

FIG. 7 illustrates yet another explanatory method in accordance with one or more embodiments of the disclosure.

FIG. 8 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to identifying, using one or more sensors of an electronic device, an unsafe condition signal while a financial application is operating on one or more processors of the electronic device and executing, by the one or more processors, one or more unsafe condition operations causing the financial application to operate in an abnormal mode of operation. Any process descriptions or blocks in flow charts should be understood as representing modules, segments, or portions of code that include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and masking or misstating, as well as preventing access to, data from financial applications, so that the data structures operable with a financial application on the one or more processors will be secured if the electronic device is misappropriated by an unauthorized user to overcome problems specifically arising in the realm of the technology associated with modern electronic device user interactive computing environment interactions.

It will be appreciated that embodiments of the disclosure described herein may be comprised of one or more conventional processors and unique stored program instructions that control the one or more processors to implement, in conjunction with certain non-processor circuits, some, most, or all of the functions of receiving an unsafe conditions command and, in response, causing a financial application to present fictitious financial information at a user interface of the electronic device. The non-processor circuits may include, but are not limited to, a radio receiver, a radio transmitter, signal drivers, clock circuits, power source circuits, and user input devices. As such, these functions may be interpreted as steps of a method to determine whether unsafe conditions occur within an environment of an electronic device, such as wen user input credentials delivered to a user interface of the electronic device comprise one or more unsafe condition credentials and, upon determining that unsafe conditions exist in the environment, causing a financial application to replace financial information associated with the financial application with fictitious financial information.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that many modern electronic devices include both financial applications and shopping applications. Illustrating by example, Motorola Mobility has launched a banking application called DIMO.sup.™ in Brazil. This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO.sup.™ are leading to users simply ceasing to carry paper currency or coins. Moreover, applications like DIMO.sup.™ have caused people to stop carrying physical credit and debit cards as well since the credit and debit card account information can simply be loaded into a smartphone, with near-field and other communication devices allowing direct transactions of money electronically.

Embodiments of the disclosure also contemplate that ensuring that such financial applications are fully fraud proof has been challenging in the past. This is true even for well-established financial technology firms. While many additional features and mechanisms have been added to financial applications, examples of which include multi-factor authentication, encryption, and the like, miscreants are still able to make fraudulent transactions. Such transactions seem to be in the news every day.

Illustrating by example, one tragic event that is repeatedly reported in the news is the “lightning kidnapping” where a nefarious actor detains a victim having a smartphone with a financial application operating thereon for just enough time to make the victim transfer funds from the financial application to the nefarious actor's account at gunpoint or knife point. Since the nefarious actor's account may have been created using fake documents, it is likely untraceable. As such, these funds may be lost forever if the victim complains to central agencies later.

What's more, in Brazil after the advent of a financial application called “Pix,” there was a forty percent increase in the number of reported muggings via Pix. The problem has become so widespread that the Central Bank of Brazil was forced to intervene in an effort to reduce the incidence of crime by placing a maximum limit of 200 Brazilian Real between the hours of 8 PM and 6 AM.

While such measures have some effect, embodiments of the disclosure contemplate that more is required to stop this criminal activity. For instance, if a person falls victim to a lighting kidnapping between the hours of 6 AM and 8 PM, the 200 BRL limit will do nothing to stop the crime.

Embodiments of the disclosure provide a solution to this madness by (1) configuring electronic devices to signal unsafe situations, (2) detecting unsafe situations, and (3) transforming to an abnormal mode of operation in financial applications to prevent or reduce the loss of user assets. In one or more embodiments, a method in an electronic device comprises identifying, with one or more sensors of the electronic device, an unsafe condition signal, received at a user interface of the electronic device, while a financial application is operating on one or more processors of the electronic device, and executing, by the one or more processors, one or more unsafe condition operations causing the financial application to operate in an abnormal mode of operation.

In one or more embodiments, a user can use a control settings menu or other control data structure of the electronic device to configure the one or more sensors of the electronic device to be aware of one or more of the following:

First, the one or more sensors can monitor for an unsafe situation password. Illustrating by example, a financial application can be configured to have two different passwords for login. One is for genuine account access while another indicates an unsafe situation. For instance, a user could set a password of 5678 to access account details and another password of 6789 to indicate that the environment of the electronic device is unsafe.

Second, a financial application can be configured to receive different fingerprint data. Illustrating by example, a user may deliver fingerprint data from an index finger to access an account in a financial application, while fingerprint data from a thumb indicates that the user of the electronic device is in an unsafe situation.

Next, the financial application can be configured to receive touch input at different areas on the user interface to signal different conditions. Illustrating by example, when there is a wide “login” user actuation target presented on the display of a smartphone to access the financial application, a user can configure different gestures along that user actuation target to provide a conditions indication. For instance, the user can configure a short tap of the user actuation target for normal login, while a long press at the user actuation target may signal unsafe conditions. In other embodiments, the user may touch the left side of the user actuation target for normal login, while touching the right side of the user actuation target signals an unsafe condition, and so forth.

In still other embodiments, an electronic device can be equipped with a silent panic button. In such cases, actuation of the silent panic button causes the financial application to enter an abnormal mode of operation.

Once the financial application enters an abnormal mode of operation, various abnormal operations can occur. Illustrating by example, in one or more embodiments the financial application can show fictitious financial information. For instance, while a real balance may be $100,000, when operating in the abnormal mode of operation the financial application may cause the balance displayed at a user interface of the electronic device to be between $300 and $600. In one or more embodiments, this fictitious financial information comprises a non-zero balance intentionally, as presenting a zero balance may cause suspicion in the mind of the miscreant. Accordingly, in one or more embodiments when a false balance is reported it is reported as a non-zero balance.

In other embodiments, the financial application can present false transaction statements when operating in the abnormal mode of operation. Illustrating by example, the financial application may create fake transactions for display purposes to prevent a criminal from doubting the data being revealed by the financial application while the financial application is operating in the abnormal mode of operation. To give such fake transactions a realistic look, in one or more embodiments the one or more processors of the electronic device cause the beneficiaries identified by the fake transactions to be actual beneficiaries of real transactions. Doing so can cause the fake transactions to look more credible.

In still other embodiments, the financial application can generate random error signals for transactions when operating in the abnormal mode of operation. For instance, if an authorized user of the financial application tries to initiate a financial transaction while the financial application is operating in the abnormal mode of operation, the abnormal mode of operation can cause the user interface to display error messages even when no errors have been created by the user interface initiating the financial transaction. In one or more embodiments, this precludes debits from occurring in accounts linked to the financial application. This can help to delay the lightning kidnapping process, potentially causing the criminal to get frustrated and flee to find another victim.

In other embodiments, the financial application can preclude the presentation of transaction alerts while operating in the abnormal mode of operation. Under these conditions, incoming emails, short message service messages, application specific messages, or other incoming electronic communications can be precluded from presentation on a display of the electronic device. This works to avoid suspicion.

Of course, these various operations can be used alone or in combination. Other operations suitable for inclusion in the abnormal mode of operation will be described below. Still others will be obvious to those of ordinary skill in the art having the benefit of this disclosure.

In one or more embodiments, an electronic device comprises one or more sensors, a user interface comprising one or more user interface output devices, and one or more processors operable with the one or more sensors and the user interface. In one or more embodiments, the one or more processors receive, from the user interface, an unsafe conditions command, and in response to the unsafe conditions command, cause a financial application to present fictitious financial information on the user interface.

In one or more embodiments, the unsafe conditions command comprises delivery of auxiliary login credentials to the financial application, examples of which include an auxiliary password, auxiliary fingerprint data, touch input at an auxiliary location, or an auxiliary user input gesture. As noted above, the fictitious financial information can comprise presenting a de minimus, non-zero balance. The fictitious financial information can also comprise one or more fictitious financial transactions.

In one or more embodiments, a method in an electronic device comprises storing, in a memory of the electronic device, one or more unsafe condition credentials for a financial application operable on one or more processors of the electronic device. Thereafter, the method comprises receiving, from a user interface of the electronic device, user input credentials and determining whether the user input credentials comprise one or more unsafe condition credentials. In one or more embodiments, upon determining that the user input credentials comprise the one or more of the unsafe condition credentials, the one or more processors cause the financial application to replace financial information associated with the financial application with fictitious financial information. In one or more embodiments, the replacement of the financial information with the fictitious financial information continues until the authorized user delivers a normal mode of operation signal to the user interface authenticating the authorized user to use the financial application in a normal mode of operation.

In one or more embodiments, when the unsafe condition credentials are delivered to the user interface of the electronic device, the one or more processors keep one or more input devices operational. Accordingly, these input devices monitor environmental conditions, including sounds, sights, location, and/or other information. The one or more processors can use the active and operational input devices to sense, hear, see, communicate, and even upload sensed data to a remote electronic device or the cloud. In one or more embodiments, those one or more processors can upload by transmitting, across a network, data representations of the one or more inputs to a remote electronic device such as another wireless communication device or a cloud-computing device.

In one or more embodiments, the one or more processors can notify other electronic devices of its location when a financial application is operating in the abnormal mode of operation. The one or more processors can further transmit ambient environmental information such as acoustic information, weather information (wind, rain), traffic information, images of people, motion information, and so forth to these other electronic devices. The one or more processors can, for instance, continually or periodically capture images of the immediate environment about the electronic device for transmission to these remote devices when the unsafe condition credentials identify an unsafe condition. In one or more embodiments, this captured information can first be stored internally within the electronic device in a region of memory that can only be erased by the operating system.

In still another embodiment, the one or more processors can periodically wake to perform the environmental monitoring with operational user input devices when unsafe conditions are detected. This works to conserve battery capacity. When operational, the one or more processors can gather information, deliver data representations of the one or more environmental inputs received to a remote electronic device, and so forth. This mode of operation advantageously allows the one or more processors to determine if an unauthorized user has taken control of the electronic device, and optionally, to notify the authorized user and/or have the authorized user communicate with the electronic device via the cloud.

Advantageously, embodiments of the disclosure provide, in an electronic device, mechanisms for an authorized user of the electronic device to deliver an unsafe condition signal to the user interface of an electronic device causing a financial application to operate in an abnormal mode of operation. This can protect a user's financial information and, more importantly, hard earned cash when an unsafe condition exists around an authorized user of the electronic device or the electronic device itself. Other advantages offered by embodiments of the disclosure will be described below. Still others will be obvious to those of ordinary skill in the art having the benefit of this disclosure.

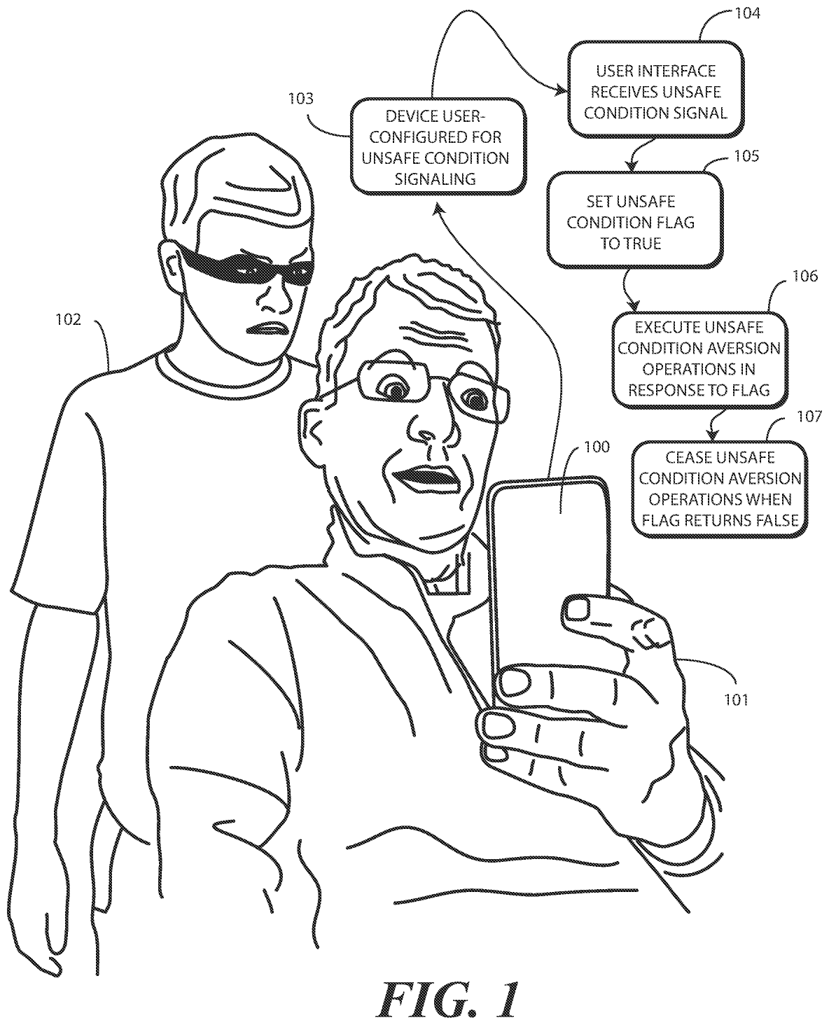

Turning now to FIG. 1, illustrated therein is one explanatory electronic device 100 configured in accordance with one or more embodiments of the disclosure. Also shown in FIG. 1 are one or more method steps for the electronic device 100. This illustrative electronic device 100 includes a user interface, one or more sensors, and one or more processors operable with the one or more sensors. In one or more embodiments, the one or more sensors of the electronic device 100 identify an unsafe condition signal, which can be received at the user interface of the electronic device 100, while a financial application is operating on the one or more processors of the electronic device 100. When the unsafe condition signal is received, the one or more processors can execute one or more unsafe condition operations causing the financial application to operate in an abnormal mode of operation.

In one or more embodiments, a user 101 can authenticate themself as an authorized user of the electronic device 100. This can be done in various ways. In some embodiments, the user 101 may deliver a password or personal identification number (PIN) to the user interface of the electronic device 100.

In other embodiments, the electronic device 100 comprises a biometric sensor that can be used for such authentication. In one or more embodiments, the biometric sensor comprises a fingerprint sensor.

In the illustrative embodiment of FIG. 1, the biometric sensor used for illustrative purposes is a combination of an imager and a depth scanner. These devices can optionally be used with a thermal sensor. It should be noted, however, that this biometric sensor could be replaced by another biometric sensor. Examples of other biometric sensors include the aforementioned fingerprint sensor, voice authentication systems, and iris scanners. Other types of biometric sensors will be obvious to those of ordinary skill in the art having the benefit of this disclosure. It should also be noted that some electronic devices configured in accordance with embodiments of the disclosure, including those that use passwords or PINS for authentication will not include any biometric sensors at all.

In the illustrative embodiment of FIG. 1, a user 101 has authenticated himself as an authorized user of the electronic device 100 in accordance with one or more embodiments of the disclosure. In this illustrative embodiment, the authentication process was “touchless” in that the user 101 need not manipulate or interact with the electronic device 100 using his fingers. To the contrary, in accordance with one or more embodiments of the disclosure, the user has been authenticated using a combination of two-dimensional imaging and depth scan imaging, optionally thermal sensing, and also optionally one or more higher authentication factors.

While using the electronic device 100, unfortunately the user 101 notices a nefarious actor 102 lurking in the shadows behind him. Fortunately, at step 103 the user has previously configured the electronic device 100 for operation in unsafe conditions.

Immediately fearful having a miscreant looking in his direction, at step 104 the user delivers an unsafe condition signal to the user interface. The one or more sensors of the electronic device identify this unsafe condition signal received at the user interface of the electronic device 100. In one or more embodiments, the unsafe condition signal received at step 104 is received while a financial application is operating on the one or more processors of the electronic device 100.

In one or more embodiments, the unsafe condition signal is delivered directly to the financial application. Embodiments of the disclosure contemplate that, in situations like the lightning kidnapping described above, the nefarious actor 102 may be demanding that the user 101 access data structures upon which the financial application operates. Thus, the nefarious actor 102 may demand that the user login to the financial application. Accordingly, in such situations step 104 can comprise the user 101 delivering the unsafe condition signal directly to the financial application.

The unsafe condition signal can take a variety of forms. In one or more embodiments, the unsafe condition signal comprises the entry of an auxiliary password to the financial application. In one or more embodiments, the auxiliary password matches a pre-stored unsafe condition password that was stored at step 103 when the electronic device 100 was configured for unsafe condition operation. In one or more embodiments, the auxiliary password differs from another password authenticating the user 101 as an authorized user able to use the financial application in a normal mode of operation.

In other embodiments, the unsafe condition signal comprises the delivery of auxiliary fingerprint data to the one or more sensors. In one or more embodiments, the auxiliary fingerprint data matches pre-stored unsafe condition fingerprint data entered to the financial application when the electronic device 100 was configured for operation in unsafe conditions at step 103. In one or more embodiments, the auxiliary fingerprint data differs from other fingerprint data that authenticates the user 101 as an authorized user of the financial application to use the financial application in a normal mode of operation.

In one or more embodiments, the unsafe condition signal comprises the delivery of auxiliary login touch input to the financial application that both matches pre-stored unsafe condition login touch input configured in the financial application at step 103 and that occurs at a location that is different from a designated location where the delivery of other login touch input to the financial application authenticates the user 101 as an authorized user to use the financial application in a normal mode of operation.

In still other embodiments, the unsafe condition signal comprises the delivery of auxiliary login touch input to the financial application that both matches pre-stored unsafe condition login touch input configured in the financial application at step 103 and that occurs for a duration that is different from another duration in which the delivery of other login touch input to the financial application authenticates the user 101 as an authorized user to use the financial application in a normal mode of operation. In still other embodiments, the unsafe condition signal comprises the actuation of a silent panic button carried by a housing of the electronic device 100.

At step 105, one or more processors of the electronic device set an unsafe condition flat to true. At step 106, the one or more processors of the electronic device 100 execute one or more unsafe condition operations causing the financial application to operate in an abnormal mode of operation.

The one or more unsafe condition operations performed at step 106 can take different forms. In one or more embodiments, the abnormal mode of operation causes the financial application to present an incorrect balance. In one or more embodiments, the incorrect balance is both less than an actual balance associated with the financial application and is also a non-zero balance. In one or more embodiments, the incorrect balance is de minimus.

In one or more embodiments, the abnormal mode of operation presents one or more fictitious transactions on a user interface of the electronic device. In instances where the financial application receives user input initiating a financial transaction while the financial application is operating in the abnormal mode of operation, the abnormal mode of operation presents one or more notifications indicating that one or more errors have occurred due to the user input initiating the financial transaction. In still other embodiments, the abnormal mode of operation precludes the presentation of any notifications by the user interface of the electronic device at step 106.

At step 107, the one or more processors cease the operation of the financial application in the abnormal mode of operation, and instead return the financial application to a normal mode of operation when the unsafe condition flag returns to false. This can occur when other user input is delivered to the user interface indicating that the unsafe condition no longer exists.

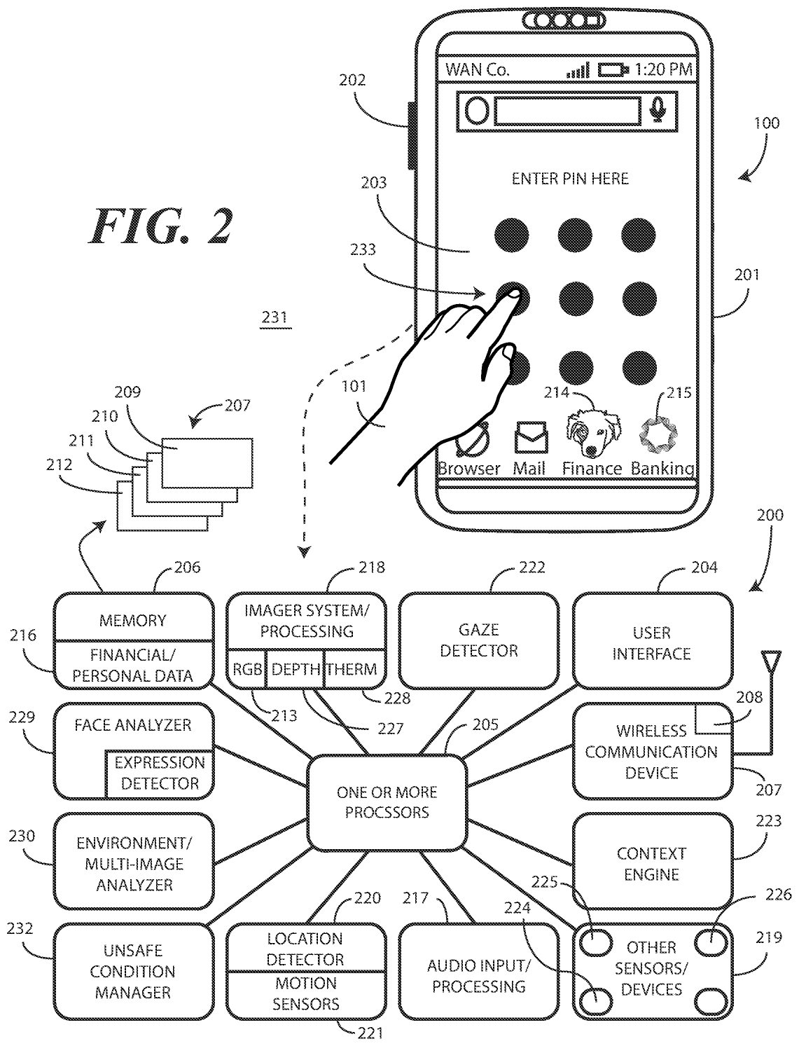

Turning now to FIG. 2, illustrated therein is one explanatory block diagram schematic 200 of one explanatory electronic device 100 configured in accordance with one or more embodiments of the disclosure. The electronic device 100 can be one of various types of devices. In one embodiment, the electronic device 100 is a portable electronic device, one example of which is a smartphone that will be used in the figures for illustrative purposes. However, it should be obvious to those of ordinary skill in the art having the benefit of this disclosure that the block diagram schematic 200 could be used with other devices as well, including conventional desktop computers, palm-top computers, tablet computers, gaming devices, media players, wearable devices, or other devices. Still other devices will be obvious to those of ordinary skill in the art having the benefit of this disclosure.

In one or more embodiments, the block diagram schematic 200 is configured as a printed circuit board assembly disposed within a housing 201 of the electronic device 100. Various components can be electrically coupled together by conductors or a bus disposed along one or more printed circuit boards. One example of such a feature is the silent panic button 202 situated on the side of the device housing 201 in this illustrative embodiment. While situated on the side of the device housing 201 in this illustrative embodiment, when the electronic device 100 is equipped with a silent panic button 202, it could be situated in other locations along the device housing 201 as well.

The illustrative block diagram schematic 200 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

The illustrative block diagram schematic 200 includes a user interface 204. In one or more embodiments, the user interface 204 includes a display 203, which may optionally be touch-sensitive. In one embodiment, users can deliver user input to the display 203 of such an embodiment by delivering touch input from a finger, stylus, or other objects disposed proximately with the display 203. In one embodiment, the display 203 is configured as an active matrix organic light emitting diode (AMOLED) display. However, it should be noted that other types of displays, including liquid crystal displays, suitable for use with the user interface 204 would be obvious to those of ordinary skill in the art having the benefit of this disclosure.

In one embodiment, the electronic device includes one or more processors 205. In one embodiment, the one or more processors 205 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the block diagram schematic 200. Each of the application processor and the auxiliary processor(s) can be configured to process and execute executable software code to perform the various functions of the electronic device with which the block diagram schematic 200 operates. A storage device, such as memory 206, can optionally store the executable software code used by the one or more processors 205 during operation.

In this illustrative embodiment, the electronic device 100 also includes a communication device 207 that can be configured for wired or wireless communication with one or more other devices or networks. The networks can include a wide area network, a local area network, and/or personal area network. The communication device 207 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 207 can include wireless communication circuitry, one of a receiver, a transmitter, or transceiver, and one or more antennas.

The electronic device 100 can optionally include a near field communication circuit 208 used to exchange data, power, and electrical signals between the electronic device 100 and another electronic device. In one embodiment, the near field communication circuit 208 is operable with a wireless near field communication transceiver, which is a form of radio-frequency device configured to send and receive radio-frequency data to and from the companion electronic device or other near field communication objects.

Where included, the near field communication circuit 208 can have its own near field communication circuit controller in one or more embodiments to wirelessly communicate with companion electronic devices using various near field communication technologies and protocols. The near field communication circuit 208 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 205 are responsible for running the operating system environment 209. The operating system environment 209 can include a kernel, one or more drivers, and an application service layer 210, and an application layer 211. The operating system environment 209 can be configured as executable code operating on one or more processors or control circuits of the electronic device 100.

The application service layer 210 can be responsible for executing application service modules. The application service modules may support one or more applications 212 or “apps.” Examples of such applications include a cellular telephone application for making voice telephone calls, a web browsing application configured to allow the user to view webpages on the display 203 of the electronic device 100, an electronic mail application configured to send and receive electronic mail, a photo application configured to organize, manage, and present photographs on the display 203 of the electronic device 100, and a camera application for capturing images with the imager 213. Collectively, these applications constitute an “application suite.” In one or more embodiments, these applications comprise one or more financial applications 214 and/or banking applications 215 that allow financial transactions to be made using the electronic device 100.

Illustrating by example, in one or more embodiments a user can deliver user input to a financial application 214 or a banking application 215 to initiate a financial transaction. In one or more embodiments, when this occurs the communication device 207 transmits a financial transaction initiation communication. In one or more embodiments, the financial transaction initiation communication comprises an electronic device identifier from which a financial transaction initiation request was received by the communication device 207.

In one or more embodiments, the one or more processors 205 are responsible for managing the applications and all financial and personal data 216 received from the user interface 204 that is to be used by the finance application 214 and/or banking application 215 after the electronic device 100 has authenticated a user as an authorized user suitable to use the finance application 214 and/or banking application 215 in a normal mode of operation.

The one or more processors 205 can also be responsible for launching, monitoring and killing the various applications and the various application service modules. In one or more embodiments, the one or more processors 205 are operable to not only kill the applications, but also to expunge any and all personal data, data, files, settings, or other configuration tools when the electronic device 100 is reported stolen to wipe the memory 206 clean of any personal data, preferences, or settings of the person previously using the electronic device 100.

In one or more embodiments, the block diagram schematic 200 includes an audio input/processor 217. The audio input/processor 217 can include hardware, executable code, and speech monitor executable code in one embodiment. The audio input/processor 217 can include, stored in memory 206, basic speech models, trained speech models, or other modules that are used by the audio input/processor 217 to receive and identify voice commands that are received with audio input captured by an audio capture device. In one embodiment, the audio input/processor 217 can include a voice recognition engine. Regardless of the specific implementation utilized in the various embodiments, the audio input/processor 217 can access various speech models to identify speech commands.

In one embodiment, the audio input/processor 217 is configured to implement a voice control feature that allows a user to speak a specific device command to cause the one or more processors 205 to execute a control operation. For example, the user may say, “Authenticate Me Now.” This statement comprises a device command requesting the one or more processors to cooperate with the authentication system 218 to authenticate a user. Consequently, this device command can cause the one or more processors 205 to access the authentication system 218 and begin the authentication process. In short, in one embodiment the audio input/processor 217 listens for voice commands, processes the commands and, in conjunction with the one or more processors 205, performs a touchless authentication procedure in response to voice input.

Various sensors and other components 219 can be operable with the one or more processors 205. FIG. 2 illustrates several examples such sensors. It should be noted that those shown in FIG. 2 are not comprehensive, as others will be obvious to those of ordinary skill in the art having the benefit of this disclosure. Additionally, it should be noted that the various sensors shown in FIG. 2 could be used alone or in combination. Accordingly, many electronic devices will employ only subsets of the sensors shown in FIG. 2, with the particular subset defined by device application.

A first example of a sensor that can be included with the other components 219 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 205, to detect an object in close proximity with—or touching—the surface of the display 203 or the housing of an electronic device 100 by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques.

Another example of a sensor is a geo-locator that serves as a location detector 220. In one embodiment, location detector 220 is able to determine location data when the touchless authentication process occurs by capturing the location data from a constellation of one or more earth orbiting satellites, or from a network of terrestrial base stations to determine an approximate location. Examples of satellite positioning systems suitable for use with embodiments of the present invention include, among others, the Navigation System with Time and Range (NAVSTAR) Global Positioning Systems (GPS) in the United States of America, the Global Orbiting Navigation System (GLONASS) in Russia, and other similar satellite positioning systems. The satellite positioning systems based location fixes of the location detector 220 autonomously or with assistance from terrestrial base stations, for example those associated with a cellular communication network or other ground based network, or as part of a Differential Global Positioning System (DGPS), as is well known by those having ordinary skill in the art. The location detector 220 may also be able to determine location by locating or triangulating terrestrial base stations of a traditional cellular network, such as a CDMA network or GSM network, or from other local area networks, such as Wi-Fi networks.

One or more motion detectors 221 can be configured as an orientation detector that determines an orientation and/or movement of the electronic device 100 in three-dimensional space. Illustrating by example, the motion detectors 221 can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The motion detectors 221 can determine the spatial orientation and/or motion of an electronic device 100 in three-dimensional space by, for example, detecting a gravitational direction and acceleration due to applied forces. In addition to, or instead of, an accelerometer, an electronic compass can be included to detect the spatial orientation of the electronic device relative to the earth's magnetic field. Similarly, one or more gyroscopes can be included to detect rotational orientation of the electronic device 100.

A gaze detector 222 can comprise sensors for detecting the user's gaze point. The gaze detector 222 can include an iris scanner. The gaze detector 222 can optionally include sensors for detecting the alignment of a user's head in three-dimensional space. Electronic signals can then be processed for computing the direction of user's gaze in three-dimensional space. The gaze detector 222 can further be configured to detect a gaze cone corresponding to the detected gaze direction, which is a field of view within which the user may easily see without diverting their eyes or head from the detected gaze direction. The gaze detector 222 can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector 222 of FIG. 2.

Other components 219 operable with the one or more processors 205 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 219 can also include proximity sensors. The proximity sensors fall in to one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 201 of the electronic device 100. In one embodiment, the signal receiver is an infrared signal receiver to receive an infrared emission from an object such as a human being when the human is proximately located with the electronic device 100. In one or more embodiments, the proximity sensor component is configured to receive infrared wavelengths of about four to about ten micrometers. This wavelength range is advantageous in one or more embodiments in that it corresponds to the wavelength of heat emitted by the body of a human being.

Additionally, detection of wavelengths in this range is possible from farther distances than, for example, would be the detection of reflected signals from the transmitter of a proximity detector component. In one embodiment, the proximity sensor components have a relatively long detection range so as to detect heat emanating from a person's body when that person is within a predefined thermal reception radius. For example, the proximity sensor component may be able to detect a person's body heat from a distance of about ten feet in one or more embodiments. The ten-foot dimension can be extended as a function of designed optics, sensor active area, gain, lensing gain, and so forth.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 205 can cause each proximity sensor component to operate at a first “effective” sensitivity so as to receive infrared emissions from a first distance. Similarly, the one or more processors 205 can cause each proximity sensor component to operate at a second sensitivity, which is less than the first sensitivity, so as to receive infrared emissions from a second distance, which is less than the first distance. The sensitivity change can be effected by causing the one or more processors 205 to interpret readings from the proximity sensor component differently.

By contrast, proximity detector components include a signal emitter and a corresponding signal receiver. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 219 can optionally include a barometer operable to sense changes in air pressure due to elevation changes or differing pressures of the electronic device 100. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 219 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device. The other components 219 can also include a flash. The other components 219 can also include a fingerprint sensor 225 or retina scanner 226.

A context engine 223 can then be operable with the various sensors to detect, infer, capture, and otherwise determine persons and actions that are occurring in an environment about the electronic device 100. For example, where included one embodiment of the context engine 223 determines assessed contexts and frameworks using adjustable algorithms of context assessment employing information, data, and events. These assessments may be learned through repetitive data analysis. Alternatively, a user may employ the user interface 204 to enter various parameters, constructs, rules, and/or paradigms that instruct or otherwise guide the context engine 223 in detecting multi-modal social cues, emotional states, moods, and other contextual information. The context engine 223 can comprise an artificial neural network or other similar technology in one or more embodiments.

In one or more embodiments, the context engine 223 is operable with the one or more processors 205. In some embodiments, the one or more processors 205 can control the context engine 223. In other embodiments, the context engine 223 can operate independently, delivering information gleaned from detecting multi-modal social cues, emotional states, moods, and other contextual information to the one or more processors 205. The context engine 223 can receive data from the various sensors. In one or more embodiments, the one or more processors 205 are configured to perform the operations of the context engine 223.

In one illustrative embodiment the authentication system 218 includes an imager 213 and a depth imager 227. The authentication system 218 can optionally include a thermal sensor 228. In one embodiment, the imager 213 comprises a two-dimensional imager configured to receive at least one image of a person within an environment of the electronic device 100. In one embodiment, the imager 213 comprises a two-dimensional RGB imager. In another embodiment, the imager 213 comprises an infrared imager. Other types of imagers suitable for use as the imager 213 of the authentication system will be obvious to those of ordinary skill in the art having the benefit of this disclosure.

The thermal sensor 228, where included, can also take various forms. In one embodiment, the thermal sensor 228 is simply a proximity sensor component included with the other components 219. In another embodiment, the thermal sensor 228 comprises a simple thermopile. In another embodiment, the thermal sensor 228 comprises an infrared imager that captures the amount of thermal energy emitted by an object. Other types of thermal sensors 228 will be obvious to those of ordinary skill in the art having the benefit of this disclosure.

The depth imager 227 can take a variety of forms. In a first embodiment, the depth imager 227 comprises a pair of imagers separated by a predetermined distance, such as three to four images. This “stereo” imager works in the same way the human eyes do in that it captures images from two different angles and reconciles the two to determine distance.

In another embodiment, the depth imager 227 employs a structured light laser. The structured light laser projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager 227 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, the depth imager 227 adds a third “z-dimension” to the x-dimension and y-dimension defining the two-dimensional image captured by the imager 213, thereby enhancing the security of using a person's face as their password in the process of authentication by facial recognition.

The authentication system 218 can be operable with a face analyzer 229 and an environmental analyzer 230. The face analyzer 229 and/or environmental analyzer 230 can be configured to determine, for example, whether a user 101 is the only person within a predefined environment 231 of the electronic device 100, or whether multiple people are within the predefined environment 231 of the electronic device 100. The predefined environment 231 is “predefined” because it is defined by a signal reception radius within which the various components 219 of the electronic device 100 can receive reliable signals.

The face analyzer 229 and/or environmental analyzer 230 can also be configured to process an image or depth scan of an object and determine whether the object matches predetermined criteria. For example, the face analyzer 229 and/or environmental analyzer 230 can operate as an identification module configured with optical and/or spatial recognition to identify objects using image recognition, character recognition, visual recognition, facial recognition, color recognition, shape recognition, and the like. Advantageously, the face analyzer 229 and/or environmental analyzer 230, operating in tandem with the authentication system 218, can be used as a facial recognition device to determine the identity of one or more persons detected about the electronic device 100.

Illustrating by example, in one embodiment when the authentication system 218 detects a person, one or both of the imager 213 and/or the depth imager 227 can capture a photograph and/or depth scan of that person. The authentication system 218 can then compare the image and/or depth scan to one or more reference files stored in the memory 206. This comparison, in one or more embodiments, is used to confirm beyond a threshold authenticity probability that the person's face—both in the image and the depth scan—sufficiently matches one or more of the reference files.

Beneficially, this optical recognition performed by the authentication system 218 operating in conjunction with the face analyzer 229 and/or environmental analyzer 230 allows access to the financial application 214 and/or banking application 215, and more importantly the financial and personal data 216, only when the person detected about the electronic device 100 are sufficiently identified as the authorized user of the electronic device 100. Accordingly, in one or more embodiments the one or more processors 205, working with the authentication system 218 and the face analyzer 229 and/or environmental analyzer 230 can determine whether a person is authorized to use the financial application 214 and/or banking application 215 in a normal mode of operation.

In one or more embodiments, the face analyzer 229 can also include an image/gaze detection-processing engine. The image/gaze detection-processing engine can process information to detect a user's gaze point. The image/gaze detection-processing engine can optionally also work with the depth scans to detect an alignment of a user's head in three-dimensional space. Electronic signals can then be delivered from the imager 213 or the depth imager 213 for computing the direction of user's gaze in three-dimensional space. The image/gaze detection-processing engine can further be configured to detect a gaze cone corresponding to the detected gaze direction, which is a field of view within which the user may easily see without diverting their eyes or head from the detected gaze direction. The image/gaze detection-processing engine can be configured to alternately estimate gaze direction by inputting images representing a photograph of a selected area near or around the eyes. It can also be valuable to determine if the user wants to be authenticated by looking directly at device. The image/gaze detection-processing engine can determine not only a gazing cone but also if an eye is looking in a particular direction to confirm user intent to be authenticated.

In one or more embodiments, an unsafe condition manager 232 can be operable with, a component of, or under the control of, the one or more processors 205 to receive, from the user interface 204, an unsafe conditions command. In one or more embodiments, when an unsafe conditions command is received from the user interface 204 can cause the financial application 214 and/or banking application 215 to operate in an abnormal mode of operation. When operating in the abnormal mode of operation, the financial application 214 and/or banking application 215 are configured present fictitious financial information on the user interface 204.

As noted above, the fictitious financial information can take various forms. In one or more embodiments, the fictitious financial information comprises presenting a de minimus, non-zero balance. In other embodiments, the fictitious financial information comprises one or more fictitious financial transactions. Other examples of fictitious financial information have been described above and will further be described below. Still others will be obvious to those of ordinary skill in the art having the benefit of this disclosure.

The unsafe conditions command can take various forms as well. In the illustrative embodiment of FIG. 2, the unsafe conditions command comprises delivery 233 of auxiliary login credentials to the financial application 214 and/or banking application 215. Illustrating by example, the financial application 214 can be configured to have two different passwords for login. One is for genuine account access while another indicates an unsafe situation. A user 101 might, as an illustrative example, set a password of 5678 to access account details and another password of 6789 to indicate that the predefined environment 231 of the electronic device 100 is unsafe.

In other embodiments, the unsafe conditions command can take other forms. In one or more embodiments, the financial application 215 can be configured to receive different fingerprint data at the fingerprint sensor 224. Illustrating by example, the user 101 may deliver fingerprint data to the fingerprint sensor 224 from an index finger to access an account in the financial application 214, while fingerprint data from a thumb, when received by the fingerprint sensor 224, indicates that the user 101 of the electronic device 100 is in an unsafe situation.

In other embodiments, the financial application 214 can be configured to receive touch input at different areas on the user interface 204 to signal different conditions. Illustrating by example, when there is a wide “login” user actuation target presented on the display 203 of the electronic device 100 to access the financial application 214, the user 101 can configure different gestures along that user actuation target for conditions indication. For instance, the user 101 can configure a short tap of the user actuation target for normal login, while a long press at the user actuation target may signal unsafe conditions. In other embodiments, the user 101 may touch the left side of the user actuation target for normal login, while touching the right side of the user actuation target signals an unsafe condition, and so forth.

In still other embodiments, an electronic device 100 can be equipped with a silent panic button 202. In such cases, actuation of the silent panic button 202 causes the financial application 214 to enter an abnormal mode of operation.

Once the financial application 214 enters an abnormal mode of operation, various abnormal operations can occur. Illustrating by example, in one or more embodiments the financial application 214 can show fictitious financial information. For instance, while a real balance may be $100,000, when operating in the abnormal mode of operation the financial application 214 may cause the balance displayed at a user interface of the electronic device 100 to be between $300 and $600. In one or more embodiments, this fictitious financial information comprises a non-zero balance intentionally, as presenting a zero balance may cause suspicion in the mind of the miscreant. Accordingly, in one or more embodiments when a false balance is reported it is reported as a non-zero balance.

In other embodiments, the financial application 214 can present false transaction statements when operating in the abnormal mode of operation. Illustrating by example, the financial application 214 may create fake transactions for display purposes to prevent a criminal from doubting the data being revealed by the financial application 214 while the financial application 214 is operating in the abnormal mode of operation. To give such fake transactions a realistic look, in one or more embodiments the one or more processors 205 of the electronic device 100 cause the beneficiaries identified by the fake transactions to be actual beneficiaries of real transactions. Doing so can cause the fake transactions to look more credible.

In still other embodiments, the financial application 214 can generate random error signals for transactions when operating in the abnormal mode of operation. For instance, if an authorized user of the financial application tries to initiate a financial transaction while the financial application 214 is operating in the abnormal mode of operation, the abnormal mode of operation can cause the user interface 204 to display error messages even when no errors have been created by the user interface 204 initiating the financial transaction. In one or more embodiments, this precludes debits from occurring in accounts linked to the financial application 214. This can help to delay the lightning kidnapping process, potentially causing the criminal to get frustrated and flee to find another victim.

In other embodiments, the financial application 214 can preclude the presentation of transaction alerts while operating in the abnormal mode of operation. Under these conditions, incoming emails, short message service messages, application specific messages, or other incoming electronic communications can be precluded from presentation on a display 203 of the electronic device 100. This works to avoid suspicion.

Of course, these various operations can be used alone or in combination. Other operations suitable for inclusion in the abnormal mode of operation will be described below. Still others will be obvious to those of ordinary skill in the art having the benefit of this disclosure.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

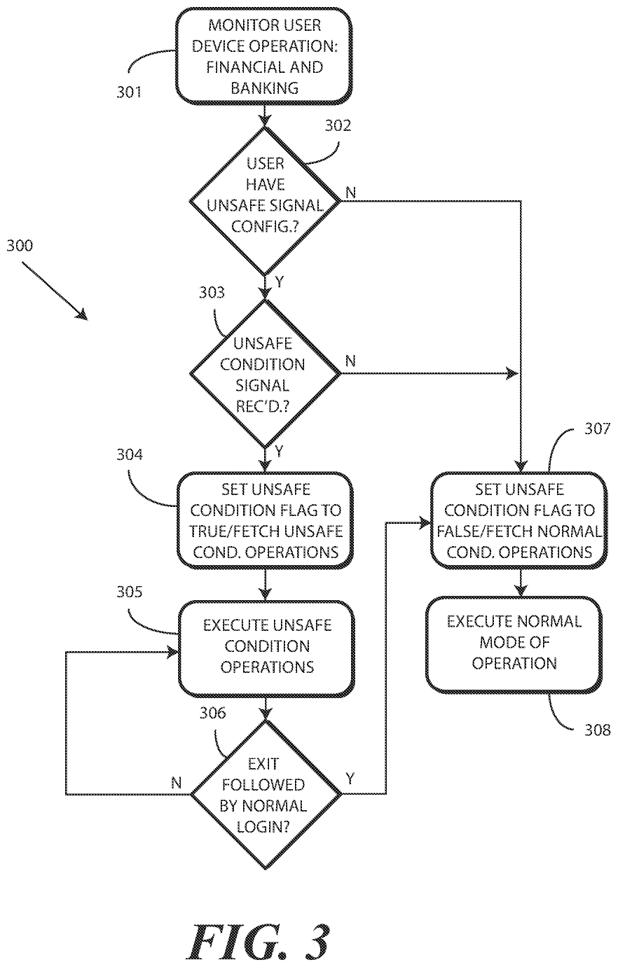

Turning now to FIG. 3, illustrated therein is one explanatory method 300 suitable for execution in an electronic device (100) in accordance with one or more embodiments of the disclosure. The method 300 of FIG. 3 identifies, with one or more sensors of the electronic device, an unsafe condition signal being received at a user interface of the electronic device while a financial application and/or banking application is operating on one or more processors of the electronic device and executes, by the one or more processors, one or more unsafe condition operations causing the financial application and/or banking application to operate in an abnormal mode of operation.

Beginning at step 301, the method 300 monitors activity in financial applications and/or banking applications operating on one or more processors of an electronic device belonging to an authorized user of the electronic device. Decision 302 determines whether the electronic device has been configured for unsafe condition operation. Configuring the electronic device for unsafe condition operation ensures that when an unsafe condition signal is received, the financial applications and/or banking application will be transformed from operating in a normal mode of operation to operating in an abnormal mode of operation.

Configuring the electronic device for unsafe condition operation can comprise predefining certain inputs that, when received, indicate that an environment around the electronic device is unsafe. Illustrating by example, this configuration step can comprise storing a pre-stored unsafe condition password in a memory of the electronic device. Alternatively, the configuration step can comprise storing pre-stored unsafe condition fingerprint data in the memory of the electronic device. In other embodiments, the configuration step can comprise storing pre-stored unsafe condition login touch input in the memory, and so forth.

Where decision 302 determines that the electronic device is configured for unsafe condition operation, the method 300 moves to decision 303. Otherwise, the method 300 moves to step 307, wherein the unsafe condition flag is set to false and any financial applications and/or banking applications are allowed to operate in a normal mode of operation.

Decision 303 identifies, optionally with one or more sensors of the electronic device, whether an unsafe condition signal is received by a user interface of the electronic device. In one or more embodiments, decision 303 identifies whether the unsafe condition signal is received while the financial application and/or banking application is operating on one or more processors of the electronic device.

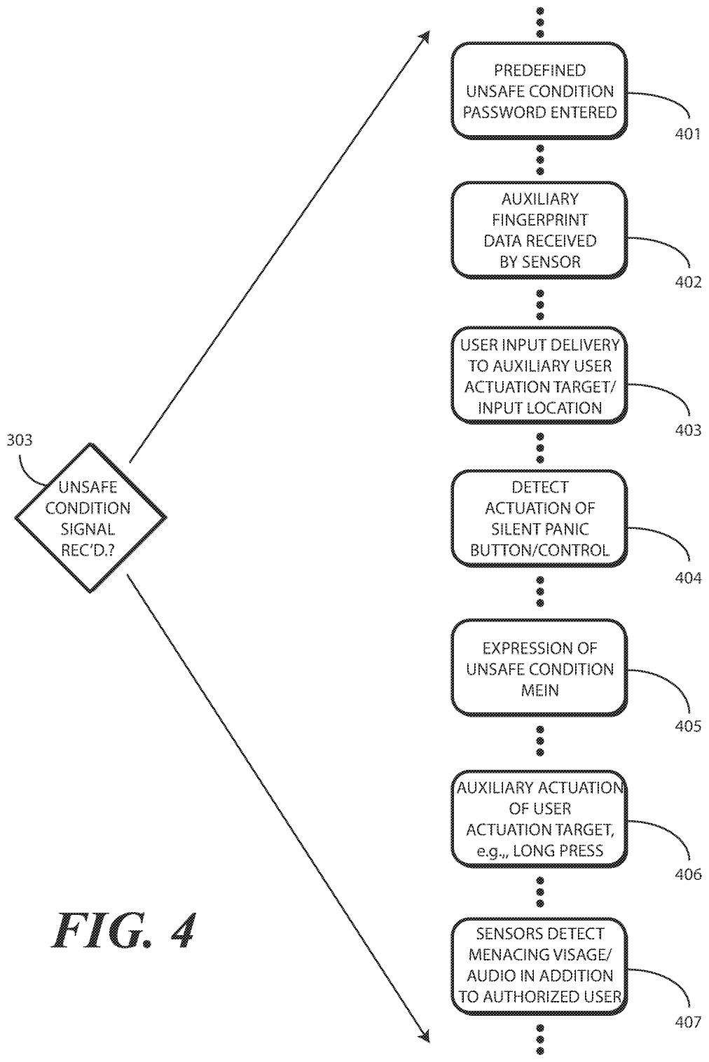

As noted above, the unsafe condition signal can take a variety of forms. Turning briefly to FIG. 4, illustrated therein are some examples of unsafe condition signals. Others will be obvious to those of ordinary skill in the art having the benefit of this disclosure.

In one or more embodiments, the unsafe condition signal comprises the entry of an auxiliary password 401 that matches a pre-stored unsafe condition password. In one or more embodiments, the auxiliary password 401 differs from another password that authenticates an authorized user to use the financial application and/or banking application in a normal mode of operation.

In other embodiments, the unsafe condition signal comprises delivery of auxiliary fingerprint data 402 that matches pre-stored unsafe condition fingerprint data. In one or more embodiments, the auxiliary fingerprint data 402 differs from other fingerprint data that authenticates an authorized user to use the financial application and/or banking application in a normal mode of operation.

In still other embodiments, the unsafe condition signal comprises the delivery of auxiliary login touch input 403,406 to the financial application and/or banking application. In one or more embodiments, the auxiliary login touch input 403 matches a pre-stored unsafe condition login touch input stored in the memory and occurs at a location that is different from a designated location where other login touch input to the financial application and/or banking application authenticates an authorized user to use the financial application and/or banking application in a normal mode of operation. In other embodiments, the auxiliary login touch input 406 matches the pre-stored unsafe condition login touch input and occurs for a duration that is different from another duration that authenticates an authorized user to use the financial application and/or banking application in a normal mode of operation.

In still other embodiments, the unsafe condition signal comprises the actuation of a silent panic button 404 carried by a housing of the electronic device. In still other embodiments, the unsafe condition signal can comprise the expression of an unsafe condition mien 405. Illustrating by example, the user may make a certain facial expression, such as sticking their tongue out or raising their eyebrows or may create a mien 405 by pulling on their chin or touching their cheek, to indicate that the environment is unsafe.

In still other embodiments, the unsafe condition signal can comprise one or more sensors of the electronic device detecting a menacing visage or audio 407 within the environment of the electronic device. Had the user (101) of FIG. 1 not seen the nefarious actor (102) lurking in the background, in one or more embodiments the one or more sensors of the electronic device (100) could passively sense the presence of the miscreant by detecting a menacing visage (e.g., the mask of FIG. 1) or audio 407 within the environment.

Turning now back to FIG. 3, when decision 303 determines that an unsafe condition signal has been received by a user interface of the electronic device, step 304 sets an unsafe condition flag to true. Optionally, step 304 can fetch one or more unsafe condition operations from memory. Otherwise, the unsafe condition flag can be set to false at step 307.

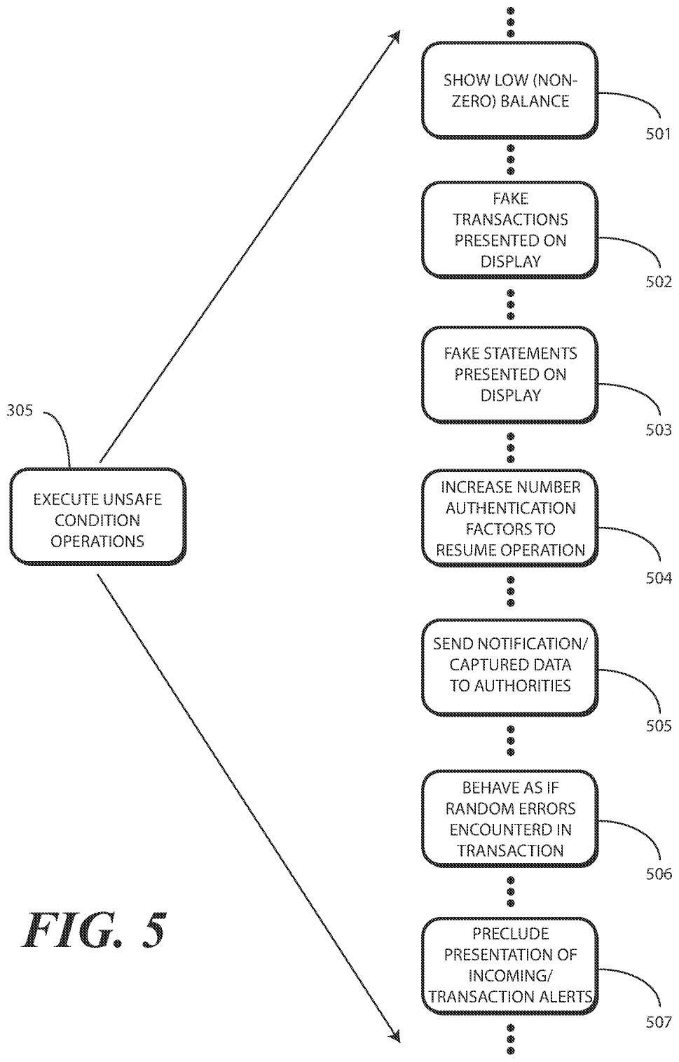

At step 305, one or more processors of the electronic device execute one or more unsafe condition operations causing the financial application and/or banking application to operate in an abnormal mode of operation. These unsafe condition operations can take various forms. Turning briefly to FIG. 5, illustrated therein are some examples of unsafe condition operations in accordance with one or more embodiments of the disclosure. Others will be obvious to those of ordinary skill in the art having the benefit of this disclosure.

In one or more embodiments, the abnormal mode of operation causes the financial application and/or banking application to present an incorrect balance 501. In one or more embodiments, the incorrect balance 501 is a non-zero balance. In other embodiments, the incorrect balance 501 is a de minimus balance. In still other embodiments, the incorrect balance 501 comprises a de minimus, non-zero balance. In one or more embodiments, the incorrect balance 501 is less than an actual balance associated with the financial application and/or banking application.

In one or more embodiments, the abnormal mode of operation occurring at step 305 comprises presenting one or more fictitious financial transactions 502 or fake financial statements 503 on the display of the electronic device. In other embodiments, the abnormal mode of operation occurring at step 305 precludes presentation of any notifications 507 by a user interface of the electronic device.

In still other embodiments, such as where step 305 detects user input initiating a financial transaction, the abnormal mode of operation occurring at step 305 can present one or more notifications indicating that one or more errors 506 have occurred in the user input initiating the financial transaction.

Step 305 can also cause communication device to transmit a wireless communication 505 to another electronic device belonging to authorities indicating that a crime may be actively occurring. This wireless communication can identify the fact that an authorized user indicates an unsafe condition exists. The message may include other information, such as an image of an unauthorized user in the environment, a location of the electronic device, sounds recorded by the one or more microphones, or other data. This alerts the authorities to the fact that a lightning kidnapping may be occurring.

Step 305 can also include increasing a number of authorized user identification factors 504 required to cause the unsafe condition flag to be reset to false. Illustrating by example, if a facial scan is all that is typically required to allow a user to use the financial application and/or banking application in a normal mode of operation, the one or more processors may require a facial scan, fingerprint, and personal identification number (PIN) code before ceasing the abnormal mode of operation. Alternatively, the one or more processors may cease the abnormal mode of operation and return to the normal mode of operation if the authorized user delivers a facial scan while at an identified owner location, such as in front of his vehicle license plate or in his living room. Other examples of elevating the number of authorized identification factors 504 will be obvious to those of ordinary skill in the art having the benefit of this disclosure.

As noted above, FIG. 5 illustrates only some of the possible additional operations that can occur at step 305 while a financial application and/or banking application operates in an abnormal mode of operation. Still others will be obvious to those of ordinary skill in the art having the benefit of this disclosure.

Turning now back to FIG. 3, decision 306 determines if the user exits the financial application and/or banking application and then later re-enters the financial application and/or banking application using a normal login mode. If not, the abnormal mode of operation of the financial application and/or banking application continues at step 305. In one or more embodiments, this continues until the authorized user delivers a normal mode of operation signal to the user interface authenticating the user interface to use the financial application and/or banking application in a normal mode of operation. Where the normal mode of operation signal is received, the unsafe condition flag is set to false at step 307, with the financial application and/or banking application operating in the normal mode of operation at step 308.

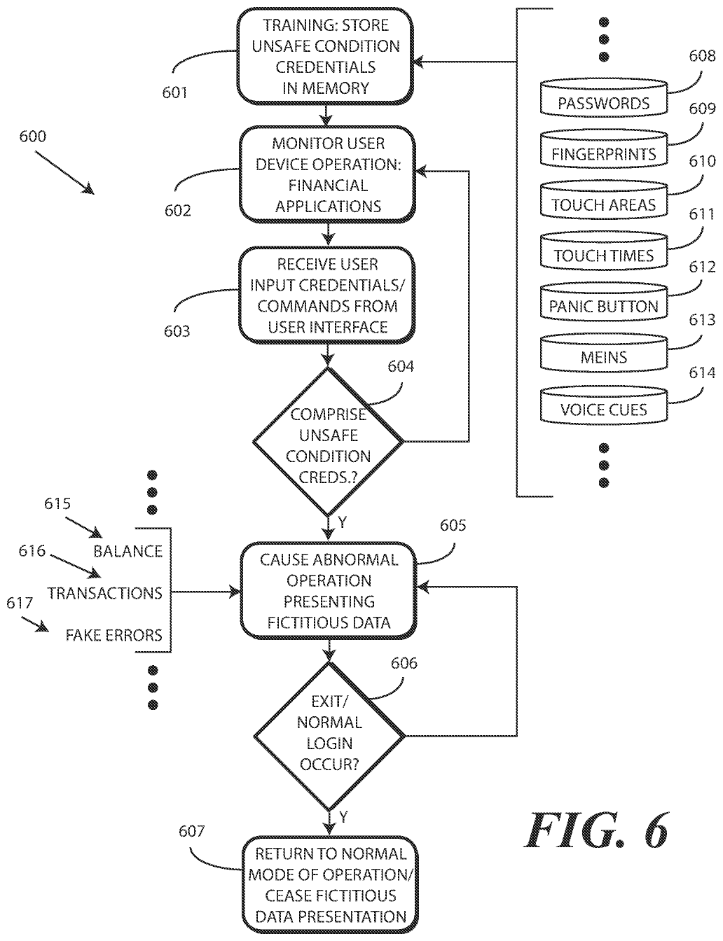

Turning now to FIG. 6, illustrated therein is another method 600 configured in accordance with one or more embodiments of the disclosure. Beginning at step 601, an electronic device is trained for unsafe condition operation. As noted above, this step 601 can comprise storing a pre-stored unsafe condition password 608, a pre-stored unsafe condition fingerprint data 609, pre-stored unsafe condition touch input locations 610, pre-stored unsafe condition touch input durations 611, pre-stored unsafe condition miens 613, and/or pre-stored unsafe condition voice cues 614 in a memory of the electronic device. Step 601 can also comprise configuring a panic button 612 to deliver an unsafe condition signal as well. Alone or in combination, these various pre-stored unsafe condition data can be referred to as unsafe conditions credentials.

Step 602 then monitors the operation of one or more financial applications and/or banking applications. Step 603 receives user input credentials for a financial application and/or banking application. Decision 604 determines whether the user input credentials comprise the one or more unsafe condition credentials.

Upon determining that the user input credentials comprise the one or more of the unsafe condition credentials, step 605 causes the financial application and/or banking application to replace financial information with fictitious financial information. Examples of financial information comprise a fictitious balance 615, fictitious transactions 616, or the presentation of fictitious error messages 617 in response to user input initiating a financial transaction.

Decision 606 determines if other user input received by the user interface fails to correspond to the unsafe condition credentials and instead match normal mode of operation credentials. Where they do, step 607 can cause the financial application and/or banking application to return to the normal mode of operation. Otherwise, step 605 comprises causing the financial application and/or banking application to replace the financial information with fictitious financial information until the authorized user delivers a normal mode of operation signal to the user interface authenticating the authorized user to use the financial application and/or banking application in the normal mode of operation.

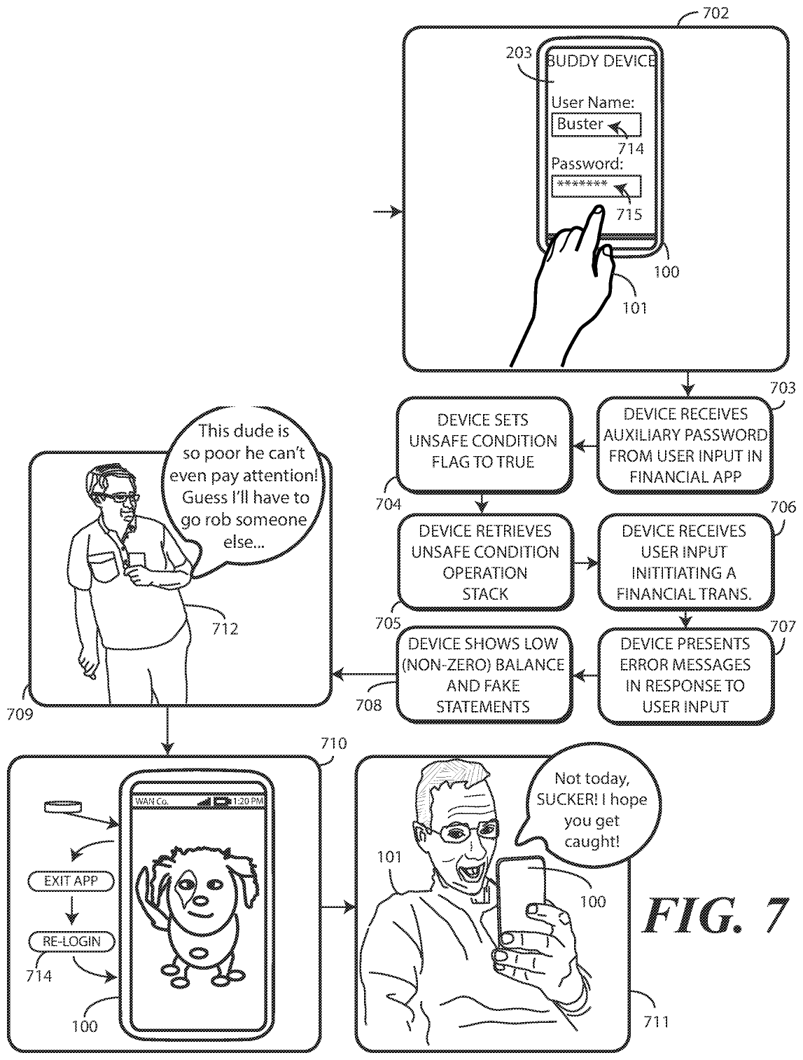

Turning now to FIG. 7, illustrated therein is another method 700 showing an electronic device 100 configured in one or more embodiments of the disclosure in operation. Beginning at step 701, a fraudster 712 dressed as a delivery man has arrived at the home of a user 101 of an electronic device 100 configured in accordance with one or more embodiments of the disclosure. The fraudster 712 claims to have a “big fancy” package 713. The fraudster 712 initiates a scam by stating, “Hey, buddy, I've got a fancy package for you, but you owe for it,” implying that the big fancy package 713 was sent collect on delivery. However, tired from a long day of committing lighting kidnappings, the fraudster 712 cuts to the chase and just says, “Hey buddy, how about you transfer cash to my account before I hurt you.”

Feeling uneasy about being physically threatened, at step 702 the user delivers touch input to the display 203 of the electronic device 100 at step 702 to gain access to a banking application. The user 101 enters a username 714 and appears to enter a password. However, rather than entering a password authenticating the user 101 to use the financial application in a normal mode of operation, the user 101 enters an auxiliary password 715 that matches a pre-stored unsafe condition password and that differs from the password allowing access to the financial application in the normal mode of operation.

At step 703, the one or more processors of the electronic device 100 receive the auxiliary password 715. At step 704 the one or more processors of the electronic device 100 set the unsafe condition flag to true. At step 705, the one or more processors retrieve one or more unsafe condition operations from memory.

At step 706, the one or more processors receive user input initiating a financial transaction to the fraudster 712. At step 707, the one or more processors present one or more notifications indicating that one or more errors have occurred in the user input initiating the financial transaction received at step 707.

Frustrated, the fraudster 712 demands to see how much money the user 101 has. At step 708, the one or more processors present one or more processors fictitious transactions and a fictitious statement on the display 203 of the electronic device 100.

Shocked by the de minimus balance shown, but not alarmed due to the fact that the balance is a non-zero balance, at step 708 the fraudster exclaims, “This dude is so poor he can't even pay attention. Guess I'll have to go rob someone else.”

Once the fraudster 712, at step 710 the user 101 exits the financial application and reopens it using a normal mode of operation signal 714 in the form of a normal mode of operation password. Accordingly, the user 101 is once again able to use the financial application in a normal mode of operation. At step 711, the user 101—delighted by the fact that he thwarted the theft without losing a dime—exclaims, “Not today, sucker! I hope you get caught.” It's a darned good thing the user 101 was using an electronic device 100 configured in accordance with embodiments of the disclosure, to be sure.

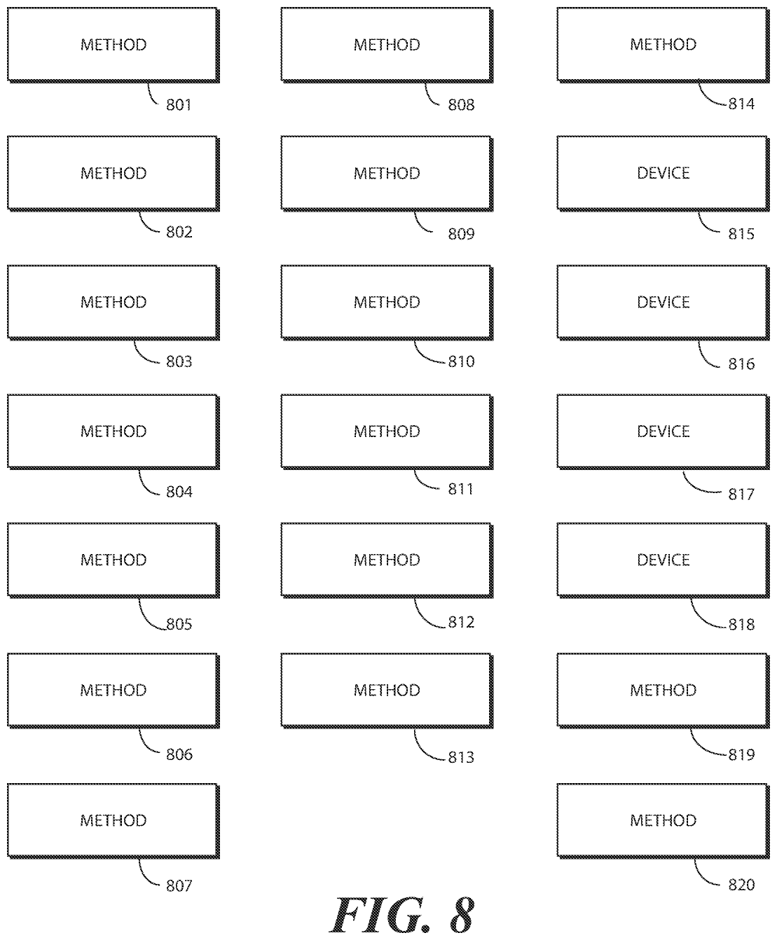

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments. Thus, the embodiments are shown as labeled boxes.

At 801, a method in an electronic device comprises identifying, with one or more sensors of the electronic device, an unsafe condition signal, received at a user interface of the electronic device, while a financial application is operating on one or more processors of the electronic device. At 801, the method comprises executing, by the one or more processors, one or more unsafe condition operations causing the financial application to operate in an abnormal mode of operation.

At 802, the unsafe condition signal of 801 comprises entry of an auxiliary password to the financial application that matches a pre-stored unsafe condition password. At 803, the auxiliary password of 803 differs from another password authenticating an authorized user to use the financial application in a normal mode of operation.

At 804, the unsafe condition signal of 801 comprises the delivery of auxiliary fingerprint data to the one or more sensors that matches pre-stored unsafe condition fingerprint data. At 805, the auxiliary fingerprint data of 804 differs from other fingerprint data authenticating an authorized user to use the financial application in a normal mode of operation.

At 806, the unsafe condition signal of 801 comprises delivery of auxiliary login touch input to the financial application that both matches pre-stored unsafe condition login touch input and occurs at a location that is different from a designated location where delivery of other login touch input to the financial application authenticates an authorized user to use the financial application in a normal mode of operation.

At 807, the unsafe condition signal of 801 comprises delivery of auxiliary login touch input to the financial application that both matches pre-stored unsafe condition login touch input and occurs for a duration that is different from another duration that authenticates an authorized user to use the financial application in a normal mode of operation. At 808, the unsafe condition signal of 801 comprises actuation of a silent panic button carried by a housing of the electronic device.

At 809, the abnormal mode of operation of 801 causes the financial application to present an incorrect balance. At 810, the incorrect balance of 809 is less than an actual balance associated with the financial application and is also a non-zero balance. At 811, the incorrect balance of 810 is de minimus. At 812, the abnormal mode of operation of 801 presents one or more fictitious transactions on a user interface of the electronic device.

At 813, the method of 801 further comprises receiving user input initiating a financial transaction. At 813, the abnormal mode of operation presents one or more notifications indicating that one or more errors have occurred in the user input initiating the financial transaction. At 814, the abnormal mode of operation of 801 precludes presentation of any notifications by a user interface of the electronic device.

At 815, an electronic device comprises one or more sensors, a user interface comprising one or more user interface output devices, and one or more processors operable with the one or more sensors and the user interface. At 815, the one or more processors receive, from the user interface, an unsafe conditions command, and in response to the unsafe conditions command, cause a financial application to present fictitious financial information on the user interface.

At 816, the fictitious financial information of 815 comprises a de minimus, non-zero balance. At 817, the fictitious financial information of 815 comprises one or more fictitious financial transactions. At 818, the unsafe conditions command of 815 comprises delivery of auxiliary login credentials to the financial application.

At 819, a method in an electronic device comprises storing, in a memory of the electronic device, one or more unsafe condition credentials for a financial application operable on one or more processors of the electronic device. At 819, the method comprises receiving, from a user interface of the electronic device, user input credentials for the financial application.

At 819, the method comprises determining, with the one or more processors, whether the user input credentials comprise one or more of the unsafe condition credentials. At 819, the method comprises, upon determining that the user input credentials comprise the one or more of the unsafe condition credentials, causing, by the one or more processors, the financial application to replace financial information associated with the financial application with fictitious financial information.

At 820, the causing the financial application to replace the financial information associated with the financial application with fictitious financial information at 819 continues until an authorized user delivers a normal mode of operation signal to the user interface authenticating the authorized user to use the financial application in a normal mode of operation.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
identifying, with one or more sensors of the electronic device, an unsafe condition signal, received at a user interface of the electronic device, while a financial application is operating on one or more processors of the electronic device; and
executing, by the one or more processors, one or more unsafe condition operations causing the financial application to operate in an abnormal mode of operation.

2. The method of claim 1, wherein the unsafe condition signal comprises entry of an auxiliary password to the financial application that matches a pre-stored unsafe condition password.

3. The method of claim 2, wherein the auxiliary password differs from another password authenticating an authorized user to use the financial application in a normal mode of operation.

4. The method of claim 1, wherein the unsafe condition signal comprises delivery of auxiliary fingerprint data to the one or more sensors that matches pre-stored unsafe condition fingerprint data.

5. The method of claim 4, wherein the auxiliary fingerprint data differs from other fingerprint data authenticating an authorized user to use the financial application in a normal mode of operation.

6. The method of claim 1, wherein the unsafe condition signal comprises delivery of auxiliary login touch input to the financial application that both:
matches pre-stored unsafe condition login touch input; and
occurs at a location that is different from a designated location where delivery of other login touch input to the financial application authenticates an authorized user to use the financial application in a normal mode of operation.

7. The method of claim 1, wherein the unsafe condition signal comprises delivery of auxiliary login touch input to the financial application that both:
matches pre-stored unsafe condition login touch input; and
occurs for a duration that is different from another duration that authenticates an authorized user to use the financial application in a normal mode of operation.

8. The method of claim 1, wherein the unsafe condition signal comprises actuation of a silent panic button carried by a housing of the electronic device.

9. The method of claim 1, wherein the abnormal mode of operation causes the financial application to present an incorrect balance.

10. The method of claim 9, wherein the incorrect balance is less than an actual balance associated with the financial application and is also a non-zero balance.

11. The method of claim 10, wherein the incorrect balance is de minimus.

12. The method of claim 1, wherein the abnormal mode of operation presents one or more fictitious transactions on a user interface of the electronic device.

13. The method of claim 1, further comprising receiving user input initiating a financial transaction, wherein the abnormal mode of operation presents one or more notifications indicating that one or more errors have occurred in the user input initiating the financial transaction.

14. The method of claim 1, wherein the abnormal mode of operation precludes presentation of any notifications by a user interface of the electronic device.

15. An electronic device, comprising:
one or more sensors;
a user interface comprising one or more user interface output devices; and
one or more processors operable with the one or more sensors and the user interface;
the one or more processors receiving, from the user interface, an unsafe conditions command, and in response to the unsafe conditions command, causing a financial application to present fictitious financial information on the user interface.

16. The electronic device of claim 15, wherein the fictitious financial information comprises a de minimus, non-zero balance.

17. The electronic device of claim 15, wherein the fictitious financial information comprises one or more fictitious financial transactions.

18. The electronic device of claim 15, wherein the unsafe condition command comprises delivery of auxiliary login credentials to the financial application.

19. A method in an electronic device, the method comprising:
storing, in a memory of the electronic device, one or more unsafe condition credentials for a financial application operable on one or more processors of the electronic device;
receiving, from a user interface of the electronic device, user input credentials for the financial application;
determining, with the one or more processors, whether the user input credentials comprise one or more of the unsafe condition credentials; and
upon determining that the user input credentials comprise the one or more of the unsafe condition credentials, causing, by the one or more processors, the financial application to replace financial information associated with the financial application with fictitious financial information.

20. The method of claim 19, wherein the causing the financial application to replace the financial information associated with the financial application with the fictitious financial information continues until an authorized user delivers a normal mode of operation signal to the user interface authenticating the authorized user to use the financial application in a normal mode of operation.
